(19) United States
(12) Patent Application Publication
(10) Pub. No.: US 2014/0358799 A1
(43) Pub. Date: Dec. 4, 2014

(54) ALERT PACKAGING AND BUNDLE SYSTEM

(71) Applicant: BANK OF AMERICA CORPORATION, Charlotte, NC (US)

(72) Inventors: Tamara S. Kingston, Peoria, AZ (US); Carrie Anne Hanson, Charlotte, NC (US); Leonard Ferman, Jacksonville, FL (US); John Perkner, Ponte Vedra Beach, FL (US); Robin Vandette, Charlotte, NC (US)

(21) Appl. No.: 13/907,269

(22) Filed: May 31, 2013

(51) Int. Cl. G06Q 30/00

(52) U.S. Cl. CPC G06Q 30/016
USPC 705/304

(57) ABSTRACT

Embodiments of the invention are directed to systems, methods and computer program products for providing alert packages. An exemplary apparatus is configured to: provide a user with an option to enroll into an alert packaging service; receive the users acceptance of enrollment in the alert packaging service, wherein enrollment in the alert packaging service comprises the user agreeing to receive one or more alert packages; receive user information associated with the user's account; and bundle one or more alerts into an alert package based at least partially on the received user information.

### BACKGROUND

Financial institutions may provide customers with alerts or notifications to aid in optimizing the customers banking experience. The alerts may be provided using various methods of communication such as email, text messaging, multimedia messaging and the like. In some instances, customers are not aware that these additional services are available. For example, customers that enroll into online banking or mobile banking and actively use the services, at times, are not aware of the additional products and services offered within the online banking application, such as providing alerts associated with a respective banking account. This can occur when the additional services are not automatically provided, but only initiated in response to the customer opting to utilize the services.

In other instances, where customers are aware of the alert services being provided by a financial institution, they may shy away from enrollment because the alerts provided are generic and do not address the particular needs of the customer regarding their personal banking experience. For example, a customer that balances their account daily may not be as interested in an alert which presents their available balance, whereas a customer that often exceeds the available funds of their accounts may find this alert to be extremely helpful. Thus customers may view generic alerts as a nuisance versus a positive aid which enhances their interaction with a respective financial institution.

Therefore, a need exist for an alert system which drives deeper customer engagement by prompting customers to enroll in an alert system which presents the customer with customized alert packages based on their financial history and personal preferences.

### BRIEF SUMMARY

Embodiments of the invention are directed to systems, methods, and computer program products for providing an alert packaging system. An exemplary apparatus comprises a memory; a processor; and a computing module stored in the memory, executable by the processor, and configured to: provide a user with an option to enroll into an alert packaging service, receive the users acceptance of enrollment in the alert packaging service, where enrollment in the alert packaging service comprises the user agreeing to receive one or more alert packages, receive user information associated with the user's account; and bundle one or more alerts into an alert package based at least partially on the received user information.

In some embodiment the module is further configured to determine one or more trends associated with the user's account based at least partially on the received user information, and determine one or more user preferences based at least partially on the one or more trends associated with the user's account.

In some embodiments, the module is further configured to determine a user-specific alert package theme based at least partially on the one or more trends associated with the user account(s) and the one or more user preferences.

In some embodiments, the module is further configured to aggregate one or more alerts into an alert package based at least partially on the user-specific alert package theme.

In some embodiments, the module is further configured to categorize one or more alert packages and categorize one or more alerts within the one or more alert packages.

In some embodiments, alerts are categorized based at least partially on a color coding scheme. In other embodiments, alerts are categorized based at least partially on a ranking system.

In some embodiments, the module is further configured to provide a user with an option to receive the one or more user-specific alert packages.

In some embodiments, the user information comprises account information associated with the user's financial institution account. In other embodiments, the user information comprises user information associated with the user's account with a third party entity.

In some embodiments, the module is further configured to receive, from the user, input indicating the user's acceptance of enrollment into the alert packaging service.

In some embodiments, the module is further configured to import settings for use with the alert packaging service, wherein the setting are imported from the user's existing alert settings.

In some embodiments, the module is further configure to receive, from the user, input indicating one or more user customized settings for use with the alert packaging service.

In some embodiments, the module is further configured to enroll the user into the alert packaging service.

In some embodiments, the module is further configured to display, via a graphical user interface, an option for a user to enroll into an alert packaging service.

In some embodiments, the module is further configured to verify the user's identity as an account holder associated with the user's financial institution account.

In some embodiments, the module is further configured to display, via a graphical user interface, one or more terms and conditions associated with the alert packaging service.

In some embodiments, the module is further configured to receive, from the user, input indicating the user agrees to the one or more terms and conditions associated with the alert packaging service.

In some embodiments, a method for providing alert packages, the method comprising providing a user with an option to enroll into an alert packaging service, receiving the users acceptance of enrollment in the alert packaging service, wherein enrollment in the alert packaging service comprises the user agreeing to receive one or more alert packages, receiving user information associated with the user, the user information comprising account information associated with the user's financial institution account; and bundling one or more alerts into an alert package based at least partially on the received user information.

In some embodiments, a computer program product for providing alert packages, the computer program product comprising a non-transitory computer-readable medium comprising a set of codes for causing a computer to provide a user with an option to enroll into an alert packaging service, receive the users acceptance of enrollment in the alert packaging service, wherein enrollment in the alert packaging service comprises the user agreeing to receive one or more alert packages, receive user information associated with the user, the user information comprising account information associated with the user's financial institution account; and bundle one or more alerts into an alert package based at least partially on the received user information.

### BRIEF DESCRIPTION OF THE DRAWINGS

Having thus described embodiments of the invention in general terms, reference will now be made to the accompanying drawings, where:

FIG. 1 is a flowchart illustrating a general process flow for providing an alert packaging system, in accordance with embodiments of the present invention;

FIG. 2 is a flowchart illustrating a general process flow for providing a user with an option to enroll into an alert packaging service, in accordance with embodiments of the present invention;

FIG. 3 is a flowchart illustrating a general process flow for receiving the users acceptance of enrollment in the alert packaging service, in accordance with embodiments of the present invention;

FIG. 4 is a flowchart illustrating a general process flow for receiving user information associated with the user, in accordance with embodiments of the present invention;

FIG. 5 is a flowchart illustrating a general process flow for bundling one or more alerts into an alert package based at least partially on the received user information, in accordance with embodiments of the present invention; and

FIG. 6 is a diagram illustrating a system environment for providing alert packages, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for providing bundled alert packages to users associated with a respective entity such as a financial institution. The invention enables an entity to provide users with customized alert packages that are bundles based on the user specific needs and prior transaction history.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, etc.) at the entity) or potential customer (e.g., a person who has submitted an application for an account, a person who is the target of marketing materials that are distributed by the entity, a person who applies for a loan that not yet been funded).

As an example, an entity (e.g., a financial institution) may provide and/or present a user (e.g., an account holder) with an option to enroll into an alert packaging service. The option may be presented the user via at least one means of the user's interacting with their electronic banking account (e.g., online banking account, mobile banking account on a portable mobile communication device, etc.), the user's social network account, email, or text message. In some embodiments, the user may select an option accept and/or deny enrollment into the alert packaging service. When the user accepts the option for enrollment in the alert packaging service, the service is activated so that the user may begin to receive customized alert packages that may aid in enhancing the users overall banking experience with the respective financial institution. Customizing the alert packages, in some embodiments, comprises receiving user information that is associated with the user. In particular, the user information may be associated with the user's account financial institution account, including transaction history, information associated with product and/or services that the user has previously been provided by the financial institution and the like. In some embodiments, the entity may utilize the user information in determining the user's preferences regarding the types of alert packages they may be interested in receiving.

In some embodiments, account information, as used herein, refers to information associated with the user's financial institution account(s) managed by a single financial institution. In other embodiments, account information may refer to information associated with the user's financial institution accounts managed by multiple distinct financial institutions.

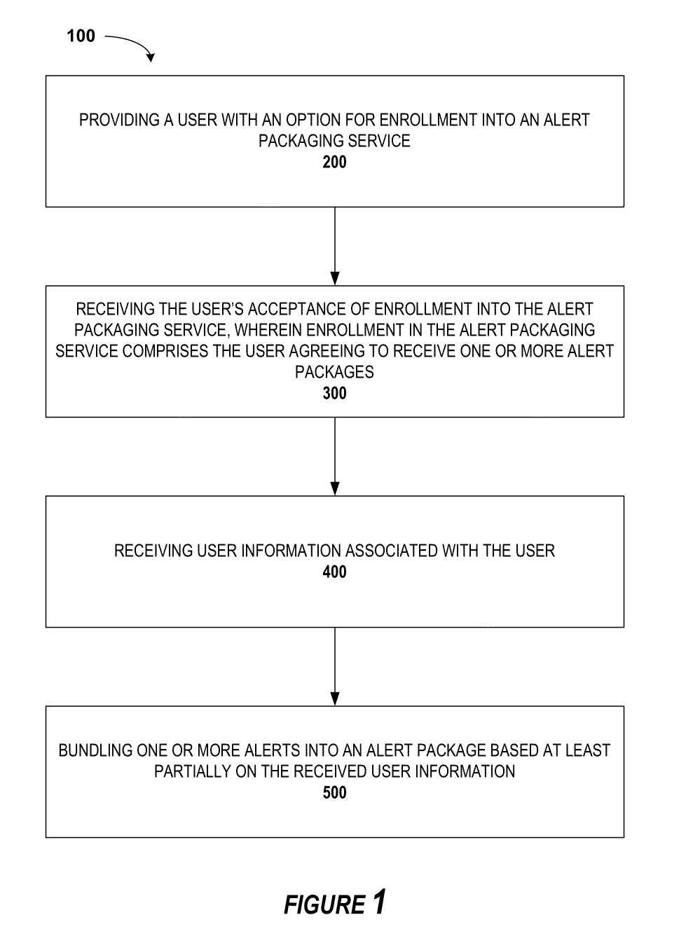

Referring now to FIG. 1, a general process flow 100 is depicted for providing an alert packaging system, according to embodiments of the present invention. At block 200, the method comprises providing a user with an option for enrollment into an alert packaging service. At block 300, the method comprises receiving the user's acceptance of enrollment in the alert packaging service. Acceptance of enrollment into the alert packaging service additionally includes the user agreeing to receive one or more alert packages. At block 400, the method comprises receiving user information associated with the user. The user information may be inclusive of account information associated with the user's financial institution account. At block 500, the method comprises bundling one or more alerts into an alert package based at least partially on the received user information. As used herein, the phrase alert packaging service may refer to a service that is capable of bundling a plurality of alerts into a single alert package such that the single alert package contains a centric theme for enhancing the user's customer experience with a respective entity. In some embodiments, the alert packages are provided to the user as-is, and the user may subsequently make changes to the packages to further customize them for their personal usage.

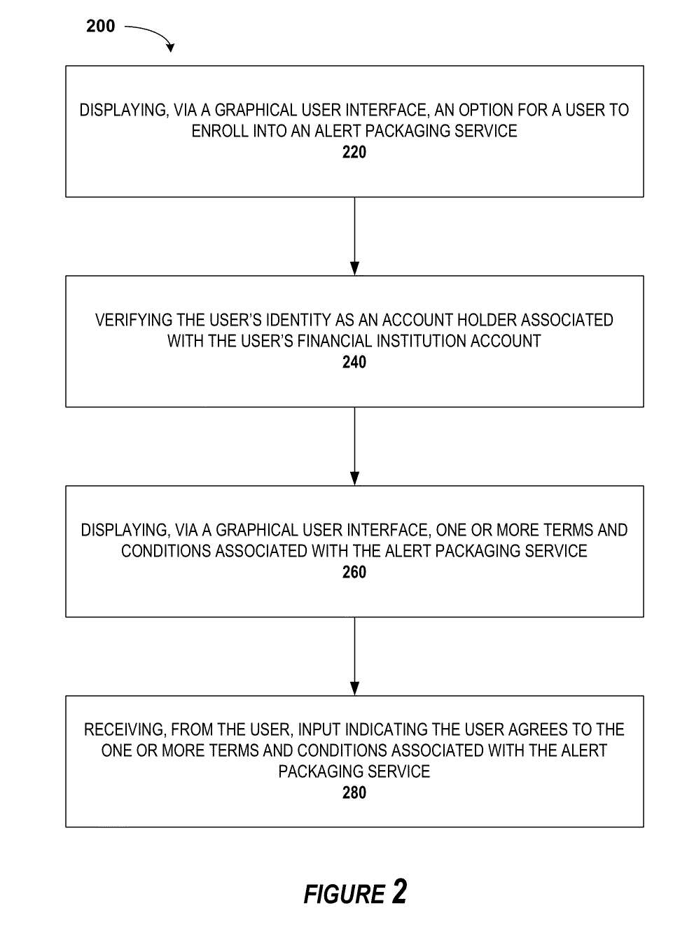

As illustrated in FIG. 2, providing the user with an option for enrollment into an alert packaging service may comprise one or more additional method steps. The additional method steps may include, but not be limited to, displaying an option for the user to enroll into an alert packaging service 220, verifying the user's identity as an account holder associated with the financial institution account 240, displaying one or more terms and conditions associated with the alert packaging service 260, and receiving input indicating that the user agrees to the one or more terms and conditions 280 presented in the prior step.

At block 220, an option which offers the user the opportunity to enroll into an alert packaging service is presented to the user. In some embodiments, the option is presented and/or displayed via a graphical user interface. The option may be presented on a display associated with various different devices which a user may use to access or interact with his/her account with a particular entity. These devices may include, but not be limited to, a computer, (e.g., a personal computer, tablet computer, desktop computer, server, laptop, etc.), a mobile device (e.g., a smartphone, cellular phone, personal digital assistant (PDA) device, music-playback device, personal GPS device, etc.), a merchant terminal, a self-service machine (e.g., self-checkout machine, etc.), a public and/or business kiosk (e.g., an Internet kiosk, ticketing kiosk, bill pay kiosk, etc.), a gaming device, and/or various combinations of the foregoing. The means for displaying the option for enrollment into an alert packaging service may vary depending on the type of device the option is presented on. For example, if the option is presented via a mobile device, the option may be presented via text messaging, multimedia messaging, email, and/or the like.

In some embodiments, a user may access their online banking account using a computer. In some instances, this may be the user's first time enrolling into the online banking service in addition to the user's first time enrolling into the alert packaging service. As such, the option for enrollment into the alert packaging service may be a secondary option associated with the basic set up for initial users of the online banking platform and/or application. For example, the user may enter their login credentials to access their online banking account, upon immediately gaining access to the online banking platform and/or application the user may be presented with a prompt entitled “Get Started”. Following the steps associated with the “Get Started” prompt may lead a user through a guided basic set up for several secondary options or services available to the user through the online banking application. Upon selecting the “Get Started” option the user may be prompted to enroll in several additional services or options for setting up paperless preferences, mobile applications, deals and reward services associated with the respective entity, and setting up alerts. When guided through the option for setting up alerts, the user may be additionally presented with an option which offers the user the opportunity to enroll into an alert packaging service. In other instances, the user may be an existing user of an online banking application associated with a respective financial institution. The user may then be presented with the option for enrollment into an alert packaging service while managing their existing alert settings from within the online banking application.

At block 240, the user's identity is verified. Verifying the user's identity may comprise verifying that the user is indeed the account holder associated with the user's financial institution account. In some embodiments, the method may further comprise denying a user enrollment into the alert packaging service based on their failure to verify their identity as the account holder associated with the user's financial institution account. In some embodiments, verifying the user's identity as an account holder associated with the user's financial institution account may comprise the user providing one or more additional login credentials that are associated with the user account. The one or more additional login credentials may include, but not be limited to, an user name and/or password associated with an online banking application linked to the user's financial institution account, a personal identification number associated with a magnetic-based payment device (e.g., a credit card, debit card, etc) linked to the user's financial account, an electronic signature, a randomly generated authentication code, a pre-selected security image and/or the like. For example, a user may be presented with an option to enroll into an alert packaging service. After indicating that he/she is interested in enrolling in the service, the user may be prompted to input one or more additional login credentials which verify the user's identity as the account holder associated with the user's financial institution account.

Verifying the user's identity as an account holder associated with the user's financial account may comprise the user answering one or more verification questions associated with the user's financial account. The one or more verification questions may include, but not be limited to, question and answer sets previously provided by the user prior to the user being prompted to answer the one or more verification questions, question and answer sets determined by the financial institution based on the user's account and/or transaction history with the financial institution, question and answer sets determined by a third-party associated with the financial institution based on the user's account and/or transaction history with the third party, and/or any combination of the aforementioned. For example, a user may be presented with an option to enroll into an alert packaging service. After indicating that he/she is interested in enrolling in the service, the user may be prompted to input answers to one or more verification questions which verify the user's identity as the account holder associated with the user's financial institution account.

It should be noted that, although in the illustrated embodiment the verification step occurs subsequent to displaying the option for the user to enroll into an alert packaging service, the user's identity may be verified prior to displaying the option for the user to enroll into an alert packaging service.

At block 260, one or more terms and conditions associated with the alert packaging service are presented to the user. In some embodiments, the one or more terms and conditions are presented and/or displayed to the user via a graphical user interface. The terms and conditions may be presented on a display associated with various different devices which a user may use to access or interact with his/her account with a particular entity. These devices may include, but not be limited to, a computer, (e.g., a personal computer, tablet computer, desktop computer, server, laptop, etc.), a mobile device (e.g., a smartphone, cellular phone, personal digital assistant (PDA) device, music-playback device, personal GPS device, etc.), a merchant terminal, a self-service machine (e.g., self-checkout machine, etc.), a public and/or business kiosk (e.g., an Internet kiosk, ticketing kiosk, bill pay kiosk, etc.), a gaming device, and/or various combinations of the foregoing. The means for displaying the terms and conditions may vary depending on the type of device the option is presented on. For example, if the terms and conditions are presented via a mobile device, the option may be presented via text messaging, multimedia messaging, email, and/or the like.

Presenting a user with one or more terms and conditions associated with an alert packaging service may additionally comprise an entity such as a financial institution determining the one or more terms and conditions to be associated with the alert packaging service. The terms and conditions may state that the user may receive an automated general alerts package. In an automated general alerts package alerts may be sent to the user following important account activities or when certain changes are made online to user's online banking account, such as a change in the user's email or home address, telephone number, Online ID or passcode, unavailable funds, or irregular card activity. It may additionally state that the user may have the option to suppress some of the alerts provided. The terms and conditions may indicate that in some instances the user may opt in for an additional voluntary alerts package. The voluntary alerts package may comprise the user manually choosing alert messages for his/her accounts. The terms and conditions may state that the entity may add new alert packages and/or cancel old alert packages. In an instance that the system cancels an existing alerts package which the user has voluntarily opted to receive the user may be notified in advance. The terms and conditions may specify that each alerts package has different options available, and the user may be asked to select from among these options upon enrollment into the alert packaging service.

The terms and conditions may additionally specify a means for communicating and/or providing the alerts to the user. For example, alerts associated with a particular alerts package may be sent to the user via an email address which the user provided as his/her primary email address to be associated with the user's financial institution account and/or online banking account. The terms in conditions may indicate that the user may additionally choose to have alerts sent to a secondary email address, a mobile device that accepts text messages, or a mobile device that configured to receive mobile application alerts through a push notification system associated with the financial institution.

The terms and conditions may additionally state that the user has the option to receive unencrypted and/or encrypted alerts within their alert packages. For instance unencrypted alerts may typically be used for alert that do not include sensitive and/or personal account information such as a passcode or account number. Unencrypted alerts may include the user's name and some information about his/her accounts. Depending upon which alerts are select to be provided to the user within a respective alerts package, information such as the user's account balance or the due date for his/her credit card payment may be included. In an instance that a user opts to receive encrypted alerts sensitive and/or personal account information may be included in the alerts.

At block 280, input is received from the user which indicates whether the user has agreed to the one or more terms and conditions associated with the alert packaging service. In some embodiments, the method may further comprise denying a user enrollment into the alert packaging service based on their failure to agree to the one or more terms and conditions associated with the alert packaging service. Receiving the user's input may further comprise presenting the user a polling option to select whether or not he/she agrees or declines to agree to the one or more terms and conditions previously presented. For example, a user may be presented with an option to enroll into an alert packaging service. After indicating that he/she is interested in enrolling in the service, the user may be presented one or more terms and conditions that are associated with the alert packaging service. The user may then be presented with a polling option to select “Yes” or “No”, and indicate whether or not they agree to the one or more terms and conditions. In some embodiments, the system may first determine that the user has read and reviewed the terms and conditions prior to allowing the user to indicate whether he/she agrees or declines to agree to the one or more terms and conditions.

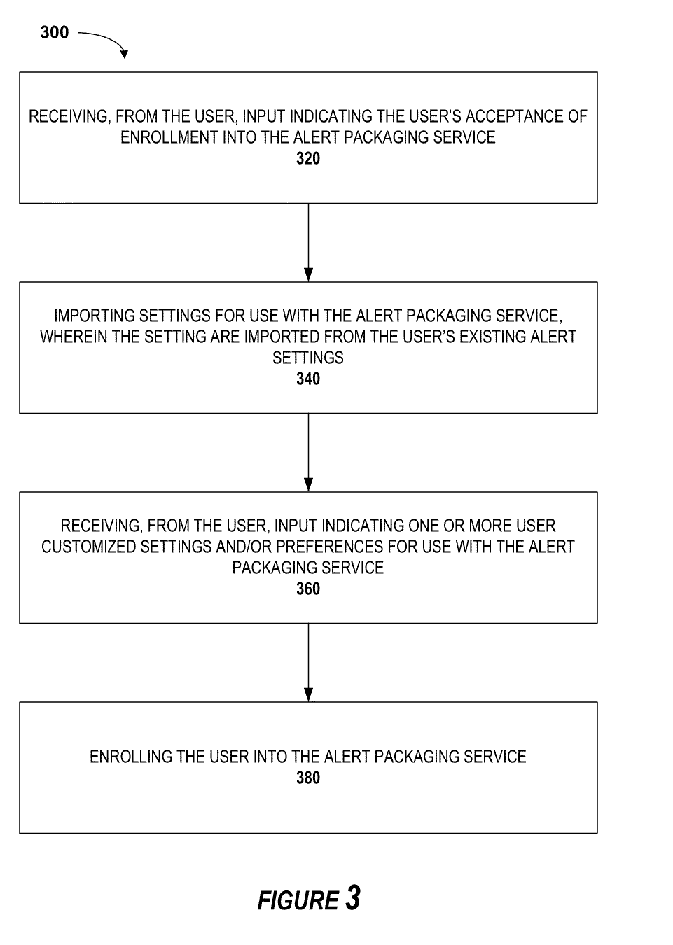

As illustrated in FIG. 3, receiving the user's acceptance of enrollment into the alert packaging service including the user agreeing to receive one or more alert packages may comprise one or more additional method steps. The additional method steps may include, but not be limited to, receiving input indicating the user's acceptance of enrollment into the alert packaging service 320, importing settings for use with the alert packaging service which may be imported from the user's existing alert settings 340, receiving input indicating one or more user customized settings and/or preferences for use with the alert packaging service 360, and enrolling the user into the alert packaging service 380.

At block 320, input is received from the user which indicates whether the user has accepted the option for enrollment into the alert packaging service. Input may be received from the user via various communication devices such as a computer, a mobile device, an automated teller machine (ATM), and the like. For example, a user may indicate acceptance of the option for enrollment into the alert packaging service via a computer terminal. The input may then be transmitted over a network to a respective entity, such as a financial institution. In some instances, the input is received by a server associated with the financial institution. The input may additionally be stored on the server for other uses such as service enrollment verification and/or renewal.

In some embodiments, input indicating the user's acceptance of enrollment into the alert packaging service may be received automatically in response to the user agreeing to one or more terms and conditions associated with the alert packaging service. For example, a user may be presented with an option to enroll into an alert packaging service. After indicating that he/she is interested in enrolling in the service, the user may be presented with one or more terms and conditions that are associated with the alert packaging service. Receiving an agreement, from the user, to comply with the one or more terms and conditions may be simultaneously indicate that the user has accepted the option for enrollment into the alert packaging service.

In some embodiments, input indicating the user's acceptance of enrollment into the alert packaging service may be received independently of the user agreeing to one or more terms and conditions associated with the alert packaging service. The user may indicate that they have accepted the option for enrollment into the alert packaging service prior to agreeing to one or more terms and conditions associated with the alert packaging service. Likewise, the user may indicate that they have accepted the option for enrollment into the alert packaging service after agreeing to one or more terms and conditions associated with the alert packaging service.

Alternatively, in some embodiments, input may be received from the user indicating that the user has denied the option for enrollment into the alert packaging service. In this instance, the user may additionally indicate that, in the future, they do not want to be presented with the option for enrollment into the alert packaging service. If a user indicates that, in the future, they do not want to be presented with the option for enrollment into the alert packaging service, the user may be required to manually enroll in the alert packaging service via a management option associated with their existing alert settings. In the instance that the user does not additionally indicate that, in the future, they do not want to be presented with the option for enrollment into the alert packaging service, the user may be randomly presented with the option during subsequent online banking sessions.

At block 340, settings are imported for use with the alert packaging service. The settings may indicate several system rules for handling alerts and/or alert packages. Settings may include, but not be limited to, rules associated with alert delivery, alert format, alert frequency and/or the like. Delivery settings may be associated with providing rules that specify the times and dates that alert packages are delivered to a user. Delivery settings may also be associated with rules that specify the means to be used for communicating alerts and/or alert packages to users. For example, alerts may be communicated via email, text messaging, multimedia messaging, from within the online banking platform, and/or the like. Alert format settings may be related to various rules associated with formatting alerts and/or alert packages. For example, alerts and/or alert packages may be encrypted or unencrypted. Alert frequency settings may be related to rules that specify how often alerts and/or alert packages should be communicated to users.

In some embodiments, alert settings are imported in response to the user indicating that they would like to import their existing alert settings for use with the alert packaging service. For example, the system may present the user with an option to import their existing alert settings. In response to the user accepting the option to import their existing alert settings, the system may first query the online banking system, and/or another system operated by the financial institution and associated with the user's online banking, to discover one or more alert settings associated with the user's account. The alert settings discovered by the query may then be imported for use with the alert packaging service. In some instances, the system may parse the discovered existing alert settings to determine which settings are applicable to the alert packaging service and which setting should not be imported for use with the alert packaging service.

In some instances, the user is does not have any existing alert settings to be imported for use with the alert packaging service. For example, the user may be the user's first time enrolling into the online banking service in addition to the user's first time enrolling into an alert service provided by the financial institution. The system may then import generic alert settings for use with the alert packaging service. In an alternative embodiment, versus importing generic alert settings the user may be presented with an option to import existing alert settings from a third party entity for use with the alert packaging service. For example, the system may present the user with an option to import their existing alert settings from a third party entity. In response to the user accepting the option to import their existing alert settings from a third party entity, the system may first query a system associated with the third party entity, to discover one or more alert settings associated with the user's account. The alert settings discovered by the query may then be imported for use with the alert packaging service. In some instances, the system may require the user to provide additional information such as login credentials for the user's account associated with the third party entity.

At block 360, input may be received from the user which indicates customization and/or user preferences which the user has specified for use with the alert packaging system. The user may alter the existing settings related to alert delivery, alert format, alert frequency and/or the like. A user may provide input which specifies the times and dates that alert packages are delivered to a user. For example, a user may only which to receive alerts on every Friday of the week. A user may additionally provide input which specifies the means to be used for communicating alerts and/or alert packages to users. For example, the user may want to receive alerts at a particular email address on. The user may additionally specify that they would only like to receive alerts related to their checking account or a secondary account such as an account which is linked to their account, but utilized by their child or business employees. Based on the information obtained and provided, at block 380, the user may be enrolled into the alert packaging service.

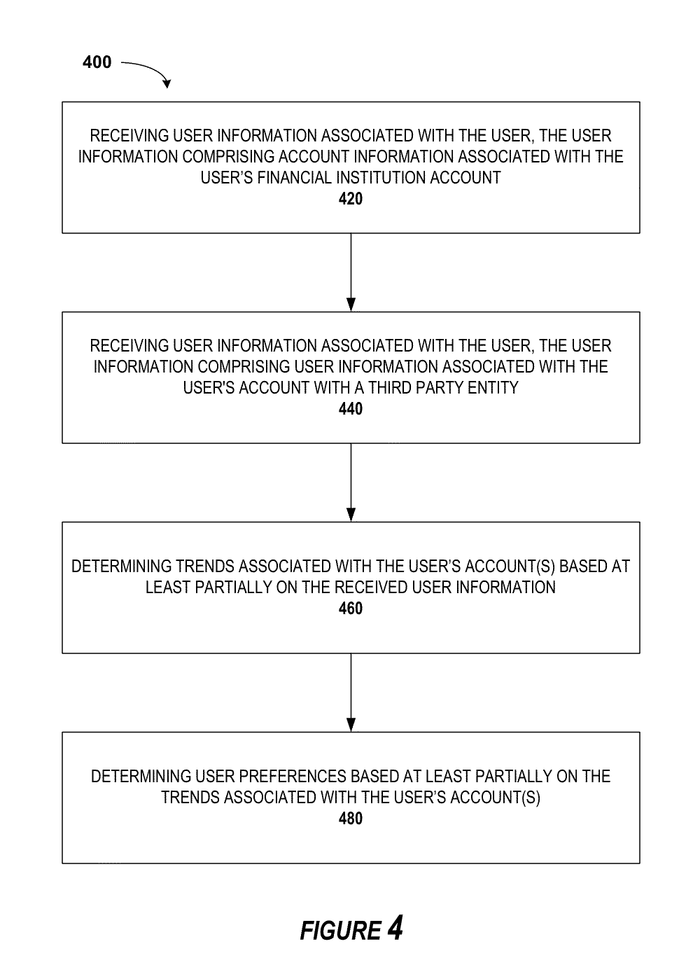

As illustrated in FIG. 4, receiving user information associated with the user may comprise one or more additional method steps. The additional method steps may include, but not be limited to, receiving user information associated with the user's financial institution account 420, receiving user information associated with the user, the user information comprising user information associated with the user's account with a third party entity 440, determining trends associated with the user's account(s) based at least partially on the received user information 460, and determining user preferences based at least partially on the received user information 480.

The user information may include both account information associated with the user's financial institution account and/or a user account with a third party entity, and personal information associated with the user. In some embodiments, the account information comprises a transaction history associated with the user's financial institution account. The transaction history includes the types of transactions, frequency of transactions, amount of each transaction, merchants associated with transactions, account balance history, etc. Additionally or alternatively, the account information may or may not comprise information associated with incorrect, inconsistent, incomplete, or corrupted transactions.

In some embodiments, the user information may comprise other information as well. For example, in some embodiments, the user information comprises personal information (e.g., demographic information, salary information, contact information (mailing address, email address, phone number, etc.), residence address history, education information, job profile information, etc.) associated with the user. In some embodiments, the personal information further comprises social network information associated with the user's social network account or other non-account related information associated with the user. In some embodiments, the user information further comprises user information (e.g., personal information, account information, etc.) associated with the user's immediate or extended family members or contacts (e.g., as determined from social network information).

In some instances the system must first gain access to the user's account online prior to receiving the account information. After accessing the user account online the system may extract financial information associated with the user's financial institution account from data displayed through the website and/or from HTML code output by the financial institution's server.

At block 420, user information associated with the user is received. In particular the user information received may be associated with the user's financial institution account. In some instances user information may be received from one or more financial institutions across a plurality of different financial products and/or a third party entity, as illustrated in block 440. For example, in one embodiment, the system receives information from the user's financial institution about a plurality of different financial products that the user is taking advantage of at that institution. For example, the user may have a checking account, savings account, investment account, mortgage, education loan, car loan, personal loan, credit card account, and/or the like maintained by the financial institution. In some embodiments, the system also receives financial information about the user from one or more other financial institutions with which the user does business. Where a financial institution maintains and/or is affiliated with the financial institution system. In some embodiments the system may be able to receive a user's financial information from such a financial institution automatically, without user input. However, where a financial institution is not affiliated with a server which houses and stores the user information such as a server associated with a third party entity, the user may need to initially provide the system with account identifying information and one or more pass codes associated with each account.

In one embodiment of the invention, the system receives, along with financial information received about a user's credit, debit, and loan accounts, information about products that were purchased by the user with money from the user's accounts. In some embodiments, the only product information that may be collected by the financial institution is information about the type of vendor that sold the goods or services to the user. For example, the financial institution may be able to provide a server associated with the financial institution with such product information as the fact that a certain debit card purchase was made at a grocery store. In other embodiments, however, the financial institution may also be able to obtain and provide the system with such product information as uniform purchase codes (UPCs) or other identifying information about the specific products or types of products purchased by the user. This level of detail about a user's purchases can be useful to the system when creating customize alert packages by aggregating one or more alerts into a single alert package, as described in greater detail below.

In some instances a server associated with the financial institution may gather and store the user's information such as financial data such that the information is available to the server for latter analysis. At block 480, the system may then analyze the user's account information to determine user preferences. For example, in one embodiment, the system determines user preferences based at least partially on determining trends identified in the user's financial, as illustrated by block 470. As such, in one embodiment, the system determines, based at least partially on the user account information associated with the user's financial institution account, which financial transactions and/or financial transaction parameters are regular and which are ad hoc. As used herein, a financial transaction may include any type of financial transaction such as, for example, a product purchase, product return, deposit, withdrawal, cash back transaction, transfer, account inquiry, and/or the like. As used herein, a transaction parameter may be any characteristic of a financial transaction, such as the geographic location of the transaction, the store in which the transaction took place, the company with which the transaction was made, the bank involved in the transaction, the type of financial transaction, the type of financial instrument used in the transaction, the amount of the transaction, a product involved in the transaction, the date of the transaction, the day of the week/month/year of the transaction, the time of day of the transaction, and/or the like.

The account information associated with the user's financial institution account and, in some instances the trends and other user preferences identified therefrom, are used to provide financial data and analysis of said data for use in bundling and/or aggregating one or more alerts into alert packages. With the ability of the system to, in some embodiments, accumulate financial data across a number of different financial institutions and identify trends and regular versus ad hoc transactions, the system can, in some embodiments, present the data to in unique ways. In some embodiments, as will be later discussed the system may also determine themes for the alert packages, such alert packages related to the user saving money, projecting the user's cash flow and alerting a user of upcoming financial transactions and hardships, and/or alerting the user of their progress towards a particular financial goal.

In some instances user trends and/or user preferences may be determined at least partially based on supplemental information provided by a respective entity. For example, the user's information associated with a user's financial institution account may be received across a plurality of financial products and/or institutions, the user information may then be aggregated after being received to determine a substantially complete financial picture for the user. In some embodiments, the user's financial information may be supplemented with user-specified financial information since it may not be possible for the financial institution system to access certain accounts or types of financial information, such as information about cash-based transactions.

Aggregated the user information such as information associated with the user's financial institution account may be stored in a server associated with the financial institution. The information may then be analyzed to provide useful information about the user to aid in customizing alert packages. For example computes the user's total net worth and/or provides financial graphs and tools that are customized for the user based on the user's financial information. Several exemplary financial tools are described below. It should be appreciated that, in some embodiments of the invention, the updates may be received regarding the user's information associated with the user's account with one or more financial institutions in real-time or near-real-time. As such, in some such embodiments, the alert packages are also updated in real-time or near-real-time. Similarly, user-preferences may, in some embodiments, be updated in real-time or near real-time.

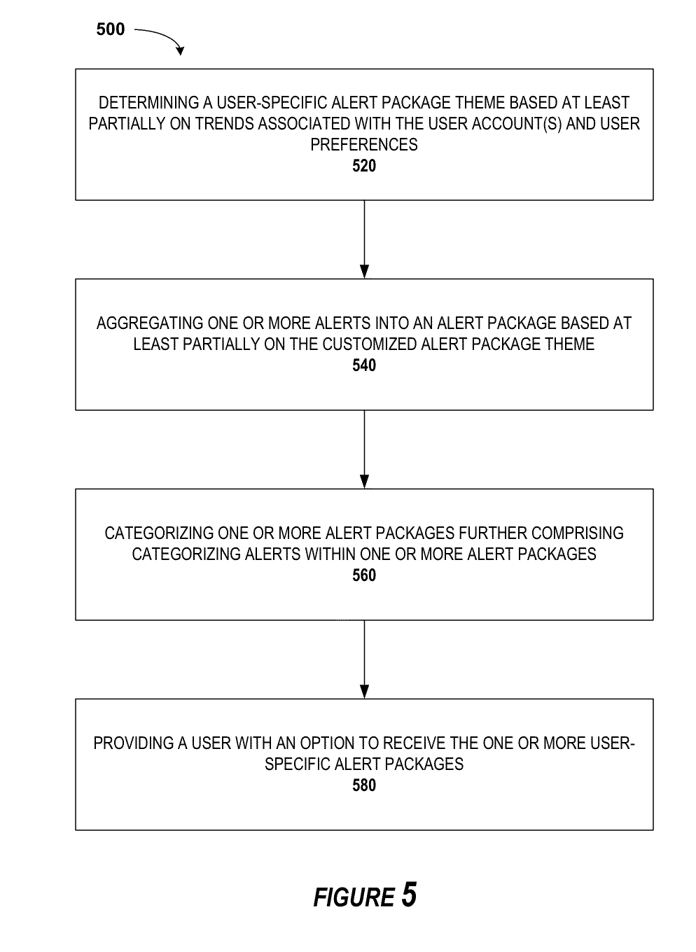

As illustrated in FIG. 5, bundling and/or aggregating one or more alerts into an alert package based at least partially on the received user information may comprise one or more additional method steps. The additional method steps may include, but not be limited to, determining a customized alert package theme based at least partially on trends associated with the user account(s) and user preferences 520, aggregating one or more alerts into an alert package based at least partially on the customized alert package theme 540, categorizing one or more alert packages further comprising categorizing alerts within one or more alert packages 560, and providing a user with an option to receive the one or more user-specific alert packages 580.

At block 520, a customized alert package theme is determined based at least partially on the trends and/or user preferences associated with the user. In some embodiment, several themes may be determined if more than one alerts packages are being created for the user. As used herein, a customized alert package theme refers to central user-specific purpose which the alerts within an alert package aim to achieve. Themes may include, but not be limited to, customer retention packages, customer deepening packages, customer savings and/or goal, customer awareness, sales and/or offer packages, introductory packages, and the like.

The customer retention package may collectively serve the purpose of maintaining and growing customer relationships. In some instances, the customer retention package is specifically geared towards improving customer relationships with at risk customers. At risk customers may be identified by trends within the customer financial data or characteristics which indicate the customer frequently exceeds their credit maximum threshold, processes delinquent payments, encounters account discrepancies, and/or the like. The user preferences may then indicate that the customer is interested in alerts that will decrease the occurrence of negligent events. Thus at block 540, one or more alerts which aid in improving customer relationships with at risk customers may be aggregated together to form a customer retention package. The customer retention package alerts may include, but not be limited to, alerts which notify the customer that they are quickly approaching their credit maximum threshold, alerts which notify customers of their available and/or low balances, alerts which notify customers of approaching bill payment due dates and/or the like.

The customer deepening packages may collectively serve the purpose of providing alerts which encourage customer to further engage in business with a particular entity. In some instances, the customer deepening package is specifically geared towards customers that meet contain a high-profile or lucrative interest for a particular entity. These customers may be identified by trends within the customer financial data or characteristics which indicate the customer has a high checking and/or saving account balances, the customer has a high, is closely approaching the age of retirement, and/or the like. The user preferences may then indicate that the customer is interested in alerts related to a specific set of products or services offered by the bank. Thus at block 540, one or more alerts which aid in deepening customer relationships may be aggregated together to form a customer deepening package. The customer deepening package alerts may include, but not be limited to, alerts which notify a customer of their eligibility for particular financial products.

The customer savings and/or goals package may collectively serve the purpose of helping manage a customer's user-specific goal. In some instances, the customer savings and/or goals package is specifically geared towards improving a customer's ability to manage and progress towards a particular goal which they have established. Customers that need to set a savings goals may be identified by trends within the customer financial data or characteristics which indicate the customer frequently has low account balances. In other instances the customer may explicitly specify a goal such as a savings goal. The user preferences may then indicate that the customer is interested in alerts that will inform the user of their progress towards a savings goal. Thus at block 540, one or more alerts which aid in informing the user of their progress towards a savings goal may be aggregated together to form a customer savings and/or goal package. The customer savings and/or goal package alerts may include, but not be limited to, alerts which notify the customer that they are quickly approaching or have exceeded a budget which they have set, alerts which notify customers of their progress towards a goal, alerts which notify customers of their eligibility for financial products to aid in achievement of their user-specific goal, and/or the like.

The customer awareness package may collectively serve the purpose of helping manage a customer's account with the financial institution. In some instances, the customer savings and/or goals package is specifically geared towards customer's that have multiple accounts with a financial institution. These customers may be identified by trends within the customer financial data or characteristics which indicate the customer may have difficulty managing several accounts. In some instances, it may be determined that a customer frequently logs into their online banking account to check their available balance. The user preferences may then indicate that the customer is interested in alerts that will inform the user of their account status. Thus at block 540, one or more alerts which aid in informing the user of their account status may be aggregated together to form a customer awareness package. The customer awareness package alerts may include, but not be limited to, alerts which notify the customer that they have received an ACH deposits, over-the-counter deposit, or s deposit over a predetermined amount, alerts which notify customers of their available balance(s), alerts which notify of over-the-counter withdrawals or withdrawals and/or purchases that exceed a predetermined amount, and/or the like. The predetermined amount(s) that qualify transactions for alerts may be specified by the user while customizing their settings.

The sales and/or offer package may collectively serve the purpose of informing the user of sales or offers which may be of interest to the user. These users may be identified by trends within the customer financial data or characteristics which indicate the user frequently purchases particular products, does business with a particular merchant, and/or the like. The user preferences may then indicate that the customer is interested in sales or offers related to products or merchants. Thus at block 540, one or more alerts which aid in informing the user of sales and/or offers related to products and merchants of interest. The sales and/or offer package alerts may include, but not be limited to, alerts which notify the customer of an upcoming sale or offer associated with a merchant of interest, alerts which notify customers of alternatives for purchasing products at lower prices, alerts which notify customers of sales and/or offers related to products of interest and/or the like. In some embodiment, the system may compare the user information with other user's information to determine alternatives for purchasing products at lower prices.

The introductory package may collectively serve the purpose of offering a variety of alerts to users that are new to online banking, the financial institution, and/or the alert packaging system. In some instances, the introductory package is provided as a start-up package for all users initially enrolling in the alert packaging service. In some instances, these users may be identified by a lack of availability of user information for use in creating more customized packages. Thus at block 540, one or more alerts which aid in helping new users get started with the alert packaging system. The introductory package alerts may include, but not be limited to, low balance alerts, direct deposit alerts, available balance alerts, atm/credit card threshold alerts, payment management alerts, and/or any alerts provided in the aforementioned alert packages.

At block 560, alert packages and/or one or more alerts contained within an alert package may be categorized. In some embodiments, the alert packages are categorized based their level of importance, demographics, similarities and/or the like. In one embodiment, alerts and/or alert packages are categorized based at least partially on a color coding scheme. To this extent, categorizing alerts based on importance may further comprise the coloration of alerts based on their importance. For examples, alerts that are determined to be of high importance may be presented in the color of red, alerts of intermediate importance may be presented in the color of yellow, and alerts that are of low importance may be presented in the color of green. In some instances, the user may specify the color which they want to be applied to a particular alert or the color which they want to apply to a level of importance associated with a plurality of alerts. In some instances, alerts are categorized based at least partially on a ranking system. The alerts may be alphabetically or numerically ranked based on importance or another general characteristic. In some embodiments, the alert packages themselves are categorized and rank based on importance, and in other embodiments, the alerts within the alerts packages are categorized and rank based on importance, or a combination of both may occur.

At block 580, an option which offers the user the opportunity to specify which customized alert packages they want to receive is presented and/or displayed. In some embodiments, the option is presented and/or displayed via a graphical user interface. The option may be presented on a display associated with various different devices which a user may use to access or interact with his/her account with a particular entity. These devices may include, but not be limited to, a computer, (e.g., a personal computer, tablet computer, desktop computer, server, laptop, etc.), a mobile device (e.g., a smartphone, cellular phone, personal digital assistant (PDA) device, music-playback device, personal GPS device, etc.), a merchant terminal, a self-service machine (e.g., self-checkout machine, etc.), a public and/or business kiosk (e.g., an Internet kiosk, ticketing kiosk, bill pay kiosk, etc.), a gaming device, and/or various combinations of the foregoing. The means for displaying the option for receiving an alert package may vary depending on the type of device the option is presented on. For example, if the option is presented via a mobile device, the option may be presented via text messaging, multimedia messaging, email, and/or the like.

In some embodiments, a user may access their online banking account using a computer. After initiating an online banking session the user may be presented with an option and accept and/or deny receiving alerts related to one or more alert packages that have been customized for the user. The user may be presented with details related to the alert packages such as the centric theme and the alerts contained within each alert package. In some instances, the user may be further presented with an option to accept the alert package as-is or further customize the alert package. For example, a user may indicate that they want to add or remove one or more alerts contained within the alert package as-is.

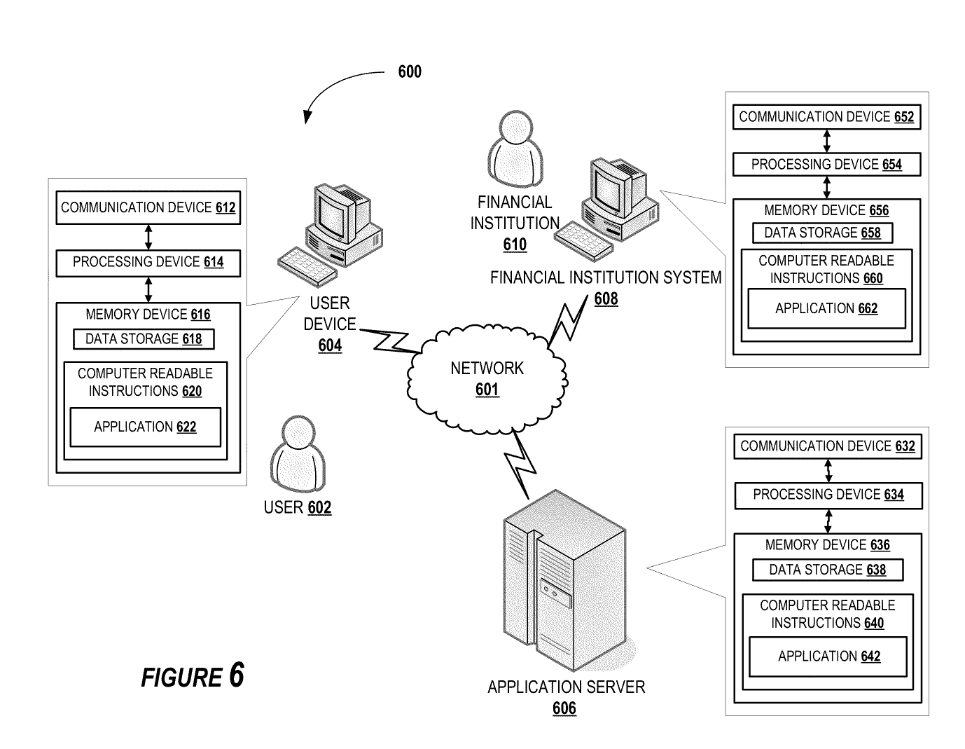

Referring now to FIG. 6, an alert packaging system environment 600, in accordance with one embodiment of the present invention, is illustrated. As shown, the financial institution system 608 is capable of sending and/or receiving information from the application server 606. Likewise, the application server 606 is capable of sending and/or receiving information from the user device 604. This communication may occur across the network 601. The network 601 may be a global area network (GAN), such as the Internet, a wide area network (WAN), a local area network (LAN), or any other type of network or combination of networks. The network 601 may provide for wireline, wireless, or a combination wireline and wireless communication between devices on the network.

The application server 606 may include a processing device 634. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The application server 606 may further include a communication device 632 that is operatively coupled to the processing device 634. The communication device 632 is capable of sending alert packaging information to the user device 204 and/or financial institution system 608 in response to determining that the user 602 has enrolled into the alert packaging service. The processing device 634 uses the communication device 632 to communicate with the network 601 and other devices on the network 601, such as, but not limited to, the financial institution system 608 and the mobile device 604. The communication device 632 generally comprises a modem, server, or other device for communicating with other devices on the network 601.

The processing device 634 is also operatively coupled to the memory device 636. The memory device 636 may house computer-readable instructions 640 which may include a server application 642. In some embodiments, the memory device 636 includes data storage 638 for storing data related to the alert packaging system environment 600 including, but not limited to, data used by the server application 642, or information provided by the user 602, user device 604, and/or financial institution system 608. For example, the data storage 638 may store all user information received from the user device 604. The server application 642 may then send the stored user information to the financial institution system 608.

The application server 606 may be operatively coupled over a network 601 to the user device 604, and, in some embodiments, to the financial institution system 608. The financial institution system 608 may include an end system and/or interface used by a business, such as a computer terminal. It should also be noted, in some embodiments the user device 604 may be interchanged with other end consumer systems, such as a mobile device. In this way, the application server 606 can send information to and receive information from the user device 604 and the financial institution system 608 to create alert packages for the user on behalf of the financial institution 608 based on information provided by various sources discussed herein. FIG. 6 illustrates only one example of an embodiment of an alert packaging system environment 600, and it will be appreciated that in other embodiments one or more of the systems, devices, or servers may be combined into a single system, device, or server, or be made up of multiple systems, devices, or servers.

In the embodiment illustrated in FIG. 6, the server application 642 may enable the user 602 and/or the financial institution 610 to interact with the system. First, the server application 642 enables a user 602 to receive alert packages based on his/her user information related to their account with the financial institution 610, via the user device 604. Next, the server application 642 enables the financial institution 610 to access the user's financial data for use in bundling one or more user-specific alert packages. The server application 642 may be capable of sending and/or receiving information to and from the user device 604 and the financial institution system 608. For example, a user device 604 may indicate that the user 602 is interested in enrolling in the alert packaging service.

The financial institution system 608 generally includes a communication device 252, a processing device 654, and a memory device 656. The processing device 654 is operatively coupled to communication device 652, and the memory device 656. The financial institution system 608 may include an input device such as a keyboard device to receive information from an individual associated with the financial institution system 608. The financial institution system 608 may additionally include a reader device including, but not limited to, a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device receives information that may be used to communicate instructions via the communication device 652 over a network 601, to other systems such as, but not limited to the application server 606 and/or other systems. The communication device 652 generally comprises a modem, server, or other device for communicating with other devices on the network 601.

The financial institution system 608 includes computer-readable instructions 660 stored in the memory device 656, which in one embodiment includes an application 662. A financial institution system 608 may also refer to any device used to provide information, messages and/or communicate to be sent to a user 602 or the application server 606, including but not limited to, information related to a user 602 receiving customized alert packages. In some embodiments, the financial institution system 608 may refer only to a plurality of components. For example, the financial institution system 608 may refer to a user device, or a user device and a financial institution device interacting with one another to provide user alert packages. As used herein, the financial institution may also be interchanged with a system associated with a third party entity.

In some embodiments, the financial institution system 608 may serve as an interface between a financial institution 610 and the application server 606 or user device 604 to enable a financial institution to provide customized alert packages. In some embodiments, the financial institution system 608 is or includes an interactive computer terminal that is configured to initiate, communicate, process, and/or facilitate providing alert packages for the user 602. A financial institution system 608 could be or include any device that may be used to communicate with a user 602 or the application server 606, such as, but not limited to, a digital sign, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, music-playback device, personal GPS device, etc.), a financial institution terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo Wii®, PlayStation Portable®, etc.), and/or various combinations of the foregoing.

In some embodiments, the financial institution system 608 may be operated in a public place (e.g., on a street corner, at the doorstep of a private residence, in an open market, at a public rest stop, etc.). In other embodiments, the financial institution system 608 is additionally or alternatively operated in a place of business (e.g., in a retail store, post office, banking center, grocery store, factory floor, etc.). In accordance with some embodiments, the financial institution system 608 may not be operated by the user of the financial institution system 608. In some embodiments, the financial institution system 608 is operated by a mobile business operator or a POS operator (e.g., merchant, vendor, salesperson, etc.). In yet other embodiments, the financial institution system 608 is owned by the entity offering the financial institution system 608 providing functionality in accordance with embodiments of the invention described herein.

FIG. 6 also illustrates a user device 604. The user device 604 may include a communication device 612, a processing device 614, and a memory device 616. The processing device 614 is operatively coupled to the communication device 612 and the memory device 616. The processing device 614 uses the communication device 616 to communicate with the network 601 and other devices on the network 601, such as, but not limited to, the application server 606 and the financial institution system 608. The communication device 616 generally has a modem, server, or other device for communicating with other devices on the network 601.

The user device 604 may have computer-readable instructions 620 stored in the memory device 616, which in one embodiment includes the user application 622. Application 622 may cause the processing device to send and receive information related to the user's 602 alert packaging preferences. The user device 604 may also include data storage 618 located in the memory device 616. The data storage 618 may be used to store information related to information related to the user's 602 alert packaging preferences. A “user device” 204 may or include any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 604 is depicted in FIG. 6, the alert packaging system 600 may contain numerous mobile devices, similar to user device 604.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for providing alert packages, the apparatus comprising:
a memory configured to store one or more alerts;
a processor; and
a module stored in the memory, executable by the processor, and configured to:
provide a user with an option to enroll into an alert packaging service;
receive the users acceptance of enrollment in the alert packaging service, wherein enrollment in the alert packaging service comprises the user agreeing to receive one or more alert packages;
receive user information associated with the user's account; and
bundle one or more alerts into an alert package based at least partially on the received user information.

2. The apparatus of claim 1, wherein the module is further configured to:
determine one or more trends associated with the user's account based at least partially on the received user information; and
determine one or more user preferences based at least partially on the one or more trends associated with the user's account.

3. The apparatus of claim 2, wherein the module is further configured to determine a user-specific alert package theme based at least partially on the one or more trends associated with the user account and the one or more user preferences.

4. The apparatus of claim 3, wherein the module is further configured to aggregate one or more alerts into an alert package based at least partially on the user-specific alert package theme.

5. The apparatus of claim 1, wherein the module is further configured to categorize one or more alert packages, and wherein the module is further configured to categorize one or more alerts within the one or more alert packages.

6. The apparatus of claim 5, wherein alerts are categorized based at least partially on a color coding scheme.

7. The apparatus of claim 5, wherein alerts are categorized based at least partially on a ranking system.

8. The apparatus of claim 1, wherein the module is further configured to provide a user with an option to receive the one or more user-specific alert packages.

9. The apparatus of claim 1, wherein the user information comprises account information associated with the user's financial institution account.

10. The apparatus of claim 1, wherein the user information comprises user information associated with the user's account with a third party entity.

11. The apparatus of claim 1, wherein the module is further configured to receive, from the user, input indicating the user's acceptance of enrollment into the alert packaging service.

12. The apparatus of claim 1, wherein the module is further configured to import settings for use with the alert packaging service, wherein the setting are imported from the user's existing alert settings.

13. The apparatus of claim 1, wherein the module is further configure to receive, from the user, input indicating one or more user customized settings for use with the alert packaging service.

14. The apparatus of claim 1, wherein the module is further configured to enroll the user into the alert packaging service.

15. The apparatus of claim 1, wherein the module is further configured to display, via a graphical user interface, an option for a user to enroll into an alert packaging service.

16. The apparatus of claim 1, wherein the module is further configured to verify the user's identity as an account holder associated with the user's financial institution account.

17. The apparatus of claim 1, wherein the module is further configured to display, via a graphical user interface, one or more terms and conditions associated with the alert packaging service.

18. The apparatus of claim 1, wherein the module is further configured to receive, from the user, input indicating the user agrees to the one or more terms and conditions associated with the alert packaging service.

19. A method for providing alert packages, the method comprising:
providing a user with an option to enroll into an alert packaging service;
receiving the users acceptance of enrollment in the alert packaging service, wherein enrollment in the alert packaging service comprises the user agreeing to receive one or more alert packages;
receiving user information associated with the user, the user information comprising account information associated with the user's financial institution account; and
bundling one or more alerts into an alert package based at least partially on the received user information.

20. The method of claim 19, wherein the method further comprises:
determining one or more trends associated with the user's account based at least partially on the received user information; and
determining one or more user preferences based at least partially on the one or more trends associated with the user's account.

21. The method of claim 20, wherein the method further comprises determining a user-specific alert package theme based at least partially on the one or more trends associated with the user account and the one or more user preferences.

22. The method of claim 19, wherein the method further comprises categorizing one or more alert packages, and wherein the module is further configured to categorize one or more alerts within the one or more alert packages.

23. A computer program product for providing alert packages, the computer program product comprising:
a non-transitory computer-readable medium comprising a set of codes for causing a computer to:
provide a user with an option to enroll into an alert packaging service;
receive the users acceptance of enrollment in the alert packaging service, wherein enrollment in the alert packaging service comprises the user agreeing to receive one or more alert packages;
receive user information associated with the user, the user information comprising account information associated with the user's financial institution account; and
bundle one or more alerts into an alert package based at least partially on the received user information.

24. The computer program product of claim 23, wherein the computer program product further comprises a set of codes for causing a computer to:
determine one or more trends associated with the user's account based at least partially on the received user information; and
determine one or more user preferences based at least partially on the one or more trends associated with the user's account.

25. The computer program product of claim 24, wherein the computer program product further comprises a set of codes for causing a computer to determine a user-specific alert package theme based at least partially on the one or more trends associated with the user account and the one or more user preferences.

26. The computer program product of claim 23, wherein the computer program product further comprises a set of codes for causing a computer to categorize one or more alert packages, and wherein the module is further configured to categorize one or more alerts within the one or more alert packages.
